(19) United States
(12) Patent Application Publication
(10) Pub. No.: US 2004/0196733 A1
(43) Pub. Date: Oct. 7, 2004

(54) Target object modification apparatus and control method

(75) Inventor: Tadashi Hayashi, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/815,652

(22) Filed: Apr. 2, 2004

(30) Foreign Application Priority Data
Apr. 4, 2003 (JP) 2003-102201

(51) Int. Cl. B28C 5/18

(52) U.S. Cl. 366/54

(57) ABSTRACT

A target object modification apparatus includes an aligner device configured to be able to manipulate the posture of a supplied target modification minute object (8), a first feed unit configured to be able to individually supply a target modification minute object (2) to the aligner device, and an injection unit configured to be able to inject modifiers onto the target modification minute object after the target modification minute object is set to a predetermined posture by the aligner device.

### FIELD OF THE INVENTION

The present invention relates to a target object modification apparatus for a target object, such as a minute object modification apparatus which adds functional modifiers to the surface of a minute object such as a cell to improve it such that it can express a specific function, and a control method for the apparatus.

### BACKGROUND OF THE INVENTION

An apparatus (Japanese Patent Application Laid-Open No. 2002-027984) shown in FIG. 10 is known as a conventional apparatus which adds functional modifiers to the surface of a minute object to improve it such that a specific function is expressed.

Referring to FIG. 10, a base material 105 made of glass or the like has openings 100, 101, 102, and 104. The openings 100, 101, 102, and 104 are connected by a channel 103 formed in the glass base material 105.

In this apparatus, a target modification minute object is fed from the opening 100. Different kinds of modifiers (modifiers A and modifiers B) are introduced from the openings 101 and 102, respectively. The target modification minute object and modifiers are mixed in the channel 103. After that, a solution mixture in which the target modification minute object and the modifiers A and B are mixed flows to the opening 104 through the meandering channel 103.

By energy (heat or light) from an energy supply unit 106 in FIG. 10, the surface of the target modification minute object reacts with the modifiers A or B during meandering. The target modification minute object which is modified by the modifiers added to its surface upon reaction can be extracted from the opening 104.

FIG. 11 is a schematic view showing the series of processes at this time.

Reference numeral 109 denotes a target modification minute object such as a cell introduced from the opening 100. Reference numerals 107 and 108 respectively denote the modifiers A and B which are introduced from the openings 101 and 102. The target modification minute object is extracted from the opening 104 while having the modifiers A or B added to its surface at random, as shown in FIG. 11.

In the above-described apparatus, in culturing, e.g., a cell, different modifiers should sometimes to be added to a side that lands on the culture medium and a side that comes into contact with the exterior.

For example, an adhesive protein such as collagen should be added to the culture medium side to stably bind the cell to the culture medium, and wet modifiers should be added to the external side to prevent the cell from drying.

As another example, in culturing a vascular cell, a coagulation inhibitor should efficiently be added to only a place corresponding to the interior in some cases. In the apparatus shown in FIG. 10, however, modifiers stick to the surface of the target modification object completely at random in the channel 103 serving as a reactor.

Hence, the modifiers are added to even an unnecessary side. It is inefficient because expensive modifiers are wasted. In the former case, the adhesive protein readily attracts contaminants. If the adhesive protein is added to the external side, it is not only inefficient but also harmful.

Additionally, in the apparatus shown in FIG. 10, reaction in the reactor does not occur unless the concentration of modifiers in the channel 103 is increased. Hence, modifiers much more than those which should actually stick to the surface of the target modification object must be prepared. At this time, most modifiers do not stick to the surface of the target modification object and must be wasted as a waste fluid.

As shown in FIG. 11, at the time of collection, even modifiers which do not stick to the surface of the target modification minute object are also output at a corresponding concentration together with the modified target modification minute object. The modifiers must be removed by purification, as needed. If a plurality of modifiers should be added, and they may react with each other, the modification amount decreases at a high probability.

### SUMMARY OF THE INVENTION

It is an object of the present invention to provide a target object modification apparatus having an arrangement effective for solving the above problems, and a control method therefor.

In order to solve the above problem, a target object modification apparatus according to the present invention comprises an aligner device configured to be able to manipulate a posture of a supplied target modification minute object, first feed means configured to be able to supply the target modification minute object to the aligner device, and injection means configured to be able to inject modifiers onto the target modification minute object after the target modification minute object is set to a predetermined posture by the aligner device.

In this arrangement, after the target modification minute object is set to a predetermined posture, modifiers can be injected onto the target modification minute object. For this reason, the modifiers can selectively efficiently be added to desired positions of a target object such as a target modification minute object.

The following modes are available on the basis of the above basic arrangement.

The apparatus can also have an opening through which the target modification minute object can be introduced, wherein the first feed means individually feeds the target object from the target modification minute object introduction opening to the aligner device. Alternatively, the apparatus can have at least one opening through which modifiers can be introduced into the aligner device, wherein the injection means is connected to the modifier introduction opening. The apparatus can have an opening from which the modified target modification minute object is extracted, and second feed means for feeding, to the extraction opening, the target modification minute object after fixing the modifiers (FIG. 1 and the like).

The apparatus can have a storage reservoir to store the target modification minute object after fixing the modifiers, wherein the second feed means can feed the target modification minute object after fixing the modifiers to the storage reservoir (FIGS. 6 and 7). The second feed means can be configured to feed the target modification minute object while keeping its posture. In this case, target modification minute objects after fixing the modifiers can be fed to the storage reservoir while being arrayed in a desired posture. The storage reservoir also serves as a culture device (FIGS. 6 and 7).

The apparatus can also comprise a target modification minute object reservoir which can store a predetermined amount of target modification minute objects, and a modifier reservoir which can store a predetermined amount of modifiers, wherein the first feed means feeds each target modification minute object from the target modification minute object reservoir to the aligner device, and the injection means is connected to the modifier reservoir (FIGS. 6 and 7).

The target modification minute object reservoir, modifier reservoir, and storage reservoir can have a detachable cartridge shape such that they can easily be handled (FIG. 1 and the like).

The apparatus may further comprise a fixing device to stably fix the modified target modification minute object (FIG. 7). An arrangement in which the aligner device also serves as the fixing device can also easily be implemented. The apparatus may comprise a recovery mechanism to execute at least one of cleaning and sterilization of the injection means (FIG. 8).

The aligner device can have a structure in which a plurality of manipulation electrodes are arranged around a recessed hole (FIG. 1 and the like). In this case, the posture of the target modification minute object is controlled by an electric field. There are also a posture control method using a magnetic field (this method is suitable when the target modification minute object is a metal component or the like) and a method using an ultrasonic wave. The electric field, magnetic field, or ultrasonic wave can also be used as the feed method of the feed means.

A plurality of aligner devices can be arrayed to be able to simultaneously modify a plurality of target modification minute objects (FIG. 9).

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the arrangement of the first embodiment of the present invention;

FIG. 2 is a view for explaining the operation of the first embodiment;

FIG. 3 is a view showing a state in which cells modified by the apparatus of the present invention are placed on a culture medium;

FIG. 4 is a view showing a state in which cells modified by a conventional apparatus are placed on a culture medium;

FIG. 5 is a view for explaining the characteristics of modifiers used for the explanation of FIGS. 3 and 4;

FIG. 6 is a view showing the arrangement of the second embodiment of the present invention;

FIG. 7 is a view showing the arrangement of a modification to the second embodiment of the present invention;

FIG. 8 is a view showing the arrangement of the third embodiment of the present invention;

FIG. 9 is a view showing the arrangement of the fourth embodiment of the present invention;

FIG. 10 is a view showing a conventional apparatus which adds modifiers to the surface of a target object; and

FIG. 11 is a schematic view for explaining the operation of the conventional apparatus which adds modifiers to the surface of a target object.

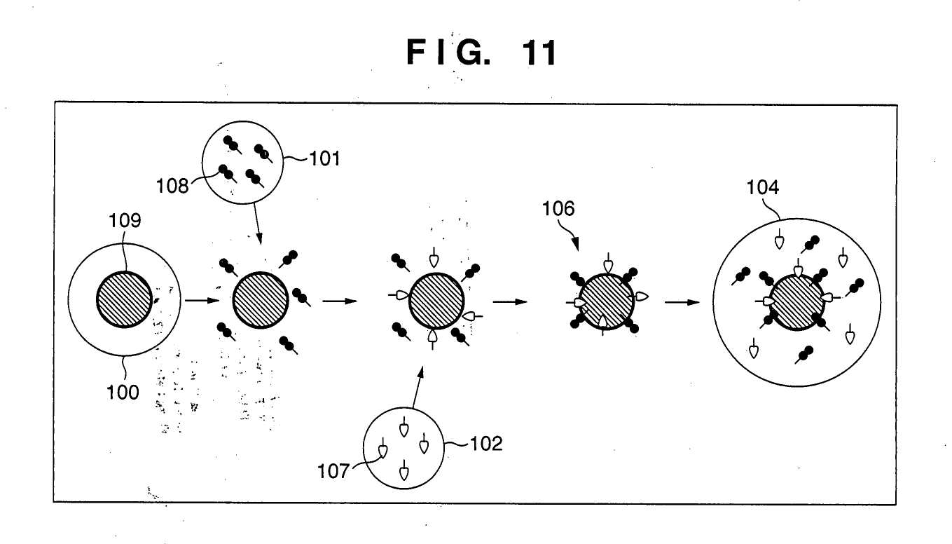

### DETAILED DESCRIPTION OF THE PREFERRED EMBODIMENTS

Preferred embodiments of the present invention will now be described in detail in accordance with the accompanying drawings.

(First Embodiment)

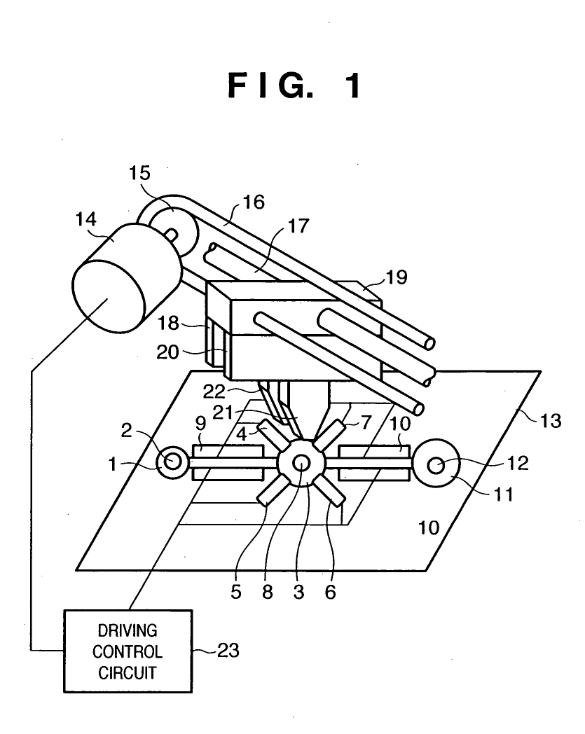

FIG. 1 is a view showing the schematic arrangement of a minute object selective modification apparatus according to the first embodiment of the present invention.

Reference numeral 1 denotes an opening through which a target modification minute object 2 is introduced; and 9 and 10, capillaries with electrodes (feed mechanisms). The target modification minute object 2 is normally a minute object such as a cell in an electrolytic solution such as physiological saline solution. Hence, the target modification minute object can be fed from the left to the right in FIG. 1 by an electric field formed by the capillaries 9 and 10 with electrodes by using an electrophoretic phenomenon or the like. The feed mechanisms are designed to be able to individually supply the target modification minute objects to an aligner device 3.

The aligner device 3 for target modification minute objects can control the posture of a target modification minute object 8 by electrodes 4 to 7 (even in this case, the electrophoretic phenomenon or the like is used) and immobilize the target modification minute object. Since the target modification minute object has small inertia, its posture can easily be controlled. As shown in FIG. 1, the aligner device 3 has the plurality of electrodes 4 to 7 around a recessed hole. In the following description, the aligner device 3 and electrodes 4 to 7 are sometimes called the aligner device 3 altogether.

An opening 11 communicates with the feed mechanism 10 to extract a modified target modification minute object 12. The above structures are integrally formed on a glass base 13.

Reference numerals 18 and 20 denote cartridge-shaped modifier reservoirs. Injection heads 21 and 22 using known piezoelectric elements or thermal jet are attached to the distal ends of the reservoirs 18 and 20, respectively. With this structure, modifiers can be injected from the injection heads 21 and 22 to the target modification minute object 8 in the aligner device 3.

The reservoirs 18 and 20 have different kinds of modifiers and can store a predetermined amount of modifiers. Reference numeral 19 denotes a cartridge holder. The cartridge-shaped reservoirs 18 and 20 can easily be attached to the cartridge holder 19 in accordance with the application purpose and exchanged.

FIG. 1 illustrates only two cartridges. However, the apparatus may have an arrangement which allows the cartridge holder 19 to have an arbitrary number of cartridges.

The cartridge holder 19 is supported by a column 17 having a slide portion and connected by a driving belt 16 to a motor 14 through a pulley 15. When the position of the cartridge holder 19 is controlled by the motor 14, the positions of the injection heads 21 and 22 with respect to the target modification minute object 8 in the aligner device 3 can arbitrarily be decided.

A driving control circuit 23 controls driving of the feed mechanisms 9 and 10, aligner device 3, electrodes 4 to 7, and motor 14. A magnifying observation device such as a microscope is arranged under the feed mechanisms 9 and 10, aligner device 3, and electrodes 4 to 7 on the base 13. The magnified image can be observed on a monitor. The operator executes driving control by operating the driving control circuit 23 by an operation member such as a joystick while looking at the image.

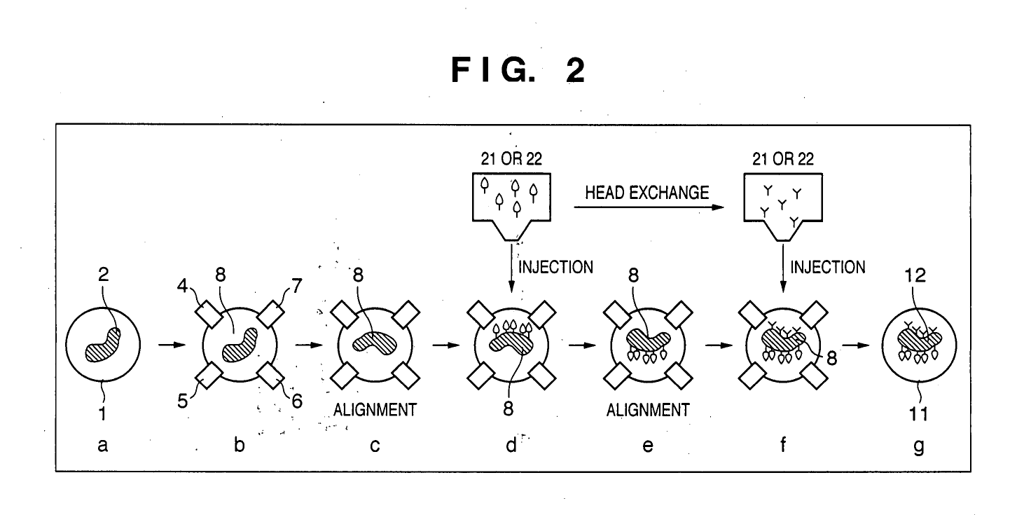

FIG. 2 is a view showing the sequence of target modification minute object selective modification using the apparatus shown in FIG. 1.

In (a), the target modification minute object 2 is introduced. In (a) to (b), the target modification minute object 2 is fed to the aligner device 3 and electrodes 4 to 7. In (c), the posture of the target modification minute object 8 is controlled and immobilized by causing the electrodes 4 to 7 to control the electric field such that the surface to which first modifiers should be added opposes the injection head 21 or 22.

In (d), the injection head 21 or 22 for the first modifiers is aligned to a position at which the modifiers are to be implanted to the target modification minute object 8. The modifiers are injected to the surface of the target modification minute object 8. After that, when a DC current is supplied from the electrodes 4 to 7 of the aligner device 3, the modifiers can be fixed by electrical stimulation or heating.

Alternatively, a head which injects an agent for promoting fixing may separately be prepared, and the fixing solution may be spread next to modifier injection.

In (e), posture control and immobilization are executed by the electrodes 4 to 7 of the aligner device 3 again such that the surface to which second modifiers should be added opposes the injection head 21 or 22. In (f), the motor 14 is driven to align the injection head 21 or 22 for the second modifiers to a position at which the modifiers are to be implanted. The modifiers are injected to the surface of the target modification minute object 8. The target modification minute object 12 thus selectively modified is fed to the extraction opening 11 and served for practical use.

The effect of this apparatus will be described next in comparison to the prior art.

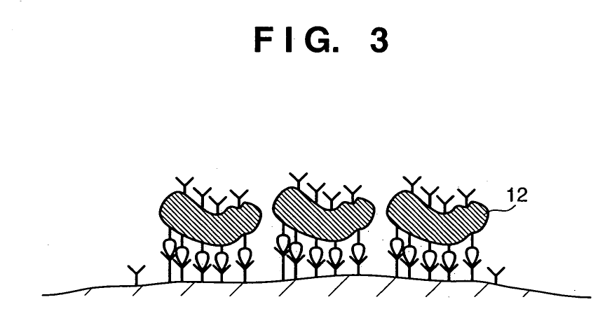

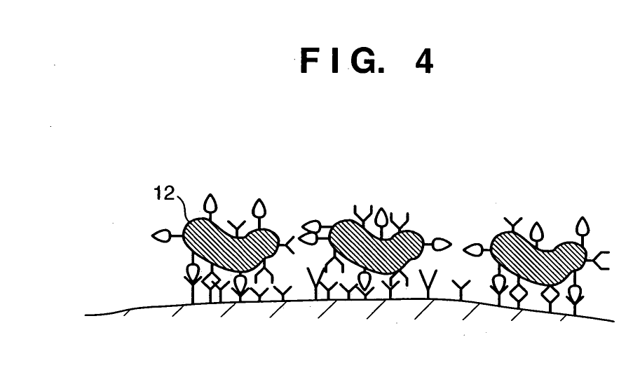

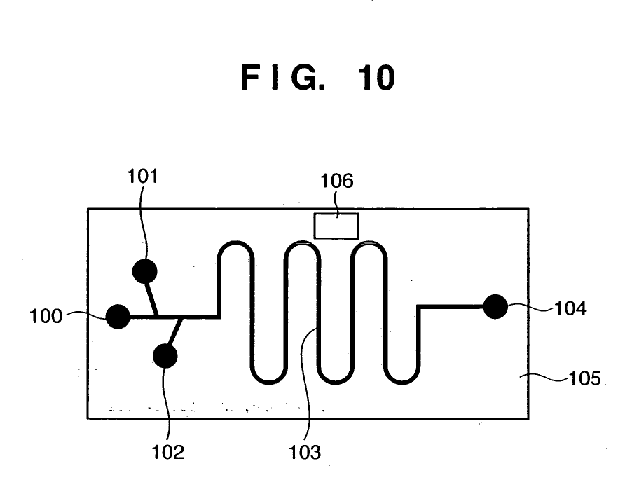

FIG. 3 is a view showing a state in which the target modification minute objects (cells) 12 modified by the apparatus are implanted in a culture medium. FIG. 4 is a view showing a state in which the target modification minute objects (cells) 12 modified by the conventional apparatus shown in FIG. 10 are implanted in a culture medium.

A modifier “Δ” is an adhesive protein fitted in a modifier “V” on the culture medium side. A modifier “U” is a cell protection modifier which serves to keep the humidity and prevent the cell 12 from drying.

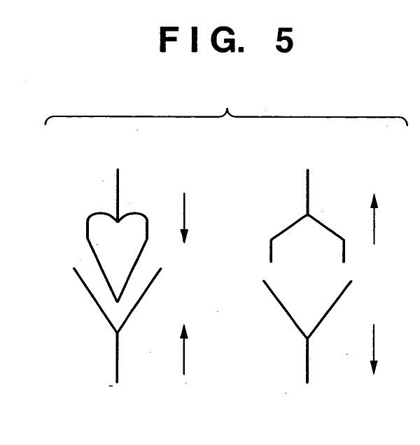

As shown in FIG. 5, the modifier A is properly fitted in the modifier V and firmly connected to it. To the contrary, the modifiers V and U repel each other. In the example shown in FIG. 3, the connection modifiers Δ are added to the culture medium side, and the modifiers U are added to the cell surface side, both modifies can exhibit corresponding functions and avoid waste.

On the other hand, in the example shown in FIG. 4, the two modifiers Δ and U are added at random. Since the repelling modifiers U are added to even the culture medium side, the fixing ratio may decrease.

In addition, since no sufficient number of protection modifiers U are added to the external side, the protection effect for the cells 12 is small. Furthermore, the adhesive modifiers Δ which are added to the surface readily attract contaminants.

As described above, when the modification apparatus of this embodiment is used, the target modification minute object can selectively be modified. Hence, the target modification minute object can express a desired function.

(Second Embodiment)

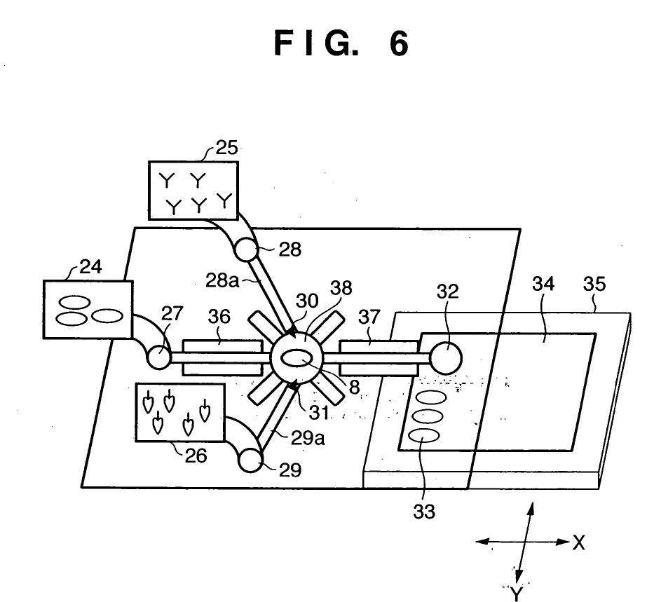

FIG. 6 is a view showing the arrangement of the second embodiment of the present invention.

Reference numerals 24 denotes a reservoir tank for target modification minute objects; 25, a reservoir tank for first modifiers; and 26, a reservoir tank for second modifiers. The reservoir tank 24 is connected, through a connector 27, to a feed mechanism 36 formed in a glass base, as in the first embodiment. The reservoir tank 24 can store a predetermined amount of target modification minute objects. Each of the reservoir tanks 25 and 26 can store a predetermined amount of modifiers.

The feed mechanism 36 supplies target modification minute objects to an aligner device 38, which is the same as in the first embodiment, in accordance with a signal from a control device. The reservoir tank 25 is connected, through a connector 28, to a capillary 28a formed in the glass base.

The capillary 28a is filled with a medium containing modifiers. An injection head 30 using a piezoelectric element or thermal jet is attached to the connection point between the capillary 28a and aligner device 38.

Similarly, the reservoir tank 26 is also connected, through a connector 29, to a capillary 29a which is formed in the glass base and filled with a medium containing modifiers. An injection head 31 is attached to the connection point between the capillary 29a and aligner device 38.

The aligner device 38 controls the posture of a target modification minute object 8 and immobilizes it to a predetermined position by controlling the electric field in the apparatus by electrodes arranged around the aligner device, as in the first embodiment. Since the injection heads 30 and 31 which inject the first and second modifiers are attached to opposite surfaces of the aligner device 38, the modifiers can simultaneously be injected. For this reason, the efficiency is high.

The target modification minute object having modifiers implanted can also appropriately be fixed by using the electrodes of the aligner device 38, as in the first embodiment.

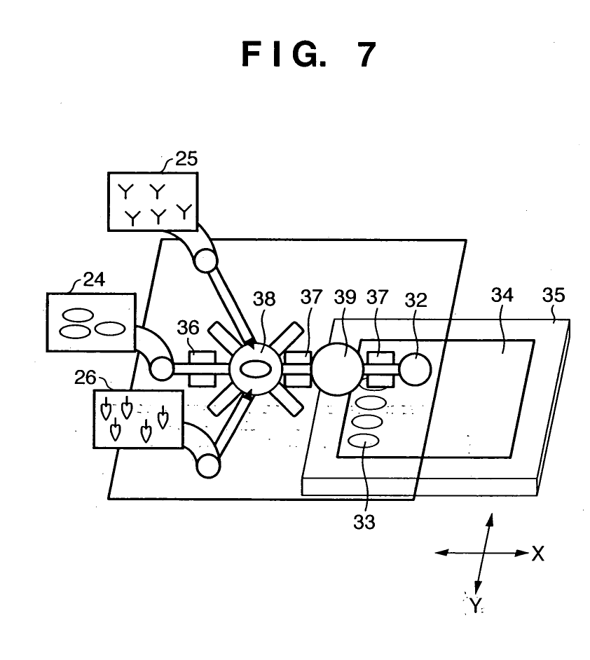

When a fixing unit 39 is independently arranged in a feed mechanism 37, as shown in FIG. 7, alignment and fixing can simultaneously be executed. In this way, the throughput can be increased as a whole.

After that, the modified target modification minute object is fed to an output port 32 by the feed mechanism 37 while keeping the posture. In the arrangement shown in FIG. 6, the output port 32 is open to the lower surface of the base. The target modification minute object is seeded in a storage unit 34 such as a culture medium under the base. In this case, the same injection mechanism as the injection head 31 or 30 may be formed at the output port 32.

The storage unit 34 is mounted on an X-Y stage 35. Control is performed to sequentially lay out modified target modification minute objects 33 on the storage unit 34.

As the storage unit 34, a rectangular culture medium is used. As the stage 35, an X-Y stage is used. However, the present invention is not limited to those. For example, when a circular storage unit is used, it is often efficient to use a stage which combines rotation and linear motion.

In the second embodiment, the operation until seeding can be executed as a sequence without exposing the target minute objects to outer air, unlike the first embodiment. When the storage unit 34 is also formed into a cartridge shape and connected to the base, all operations can be ended without exposing the target minute objects to outer air at all.

(Third Embodiment)

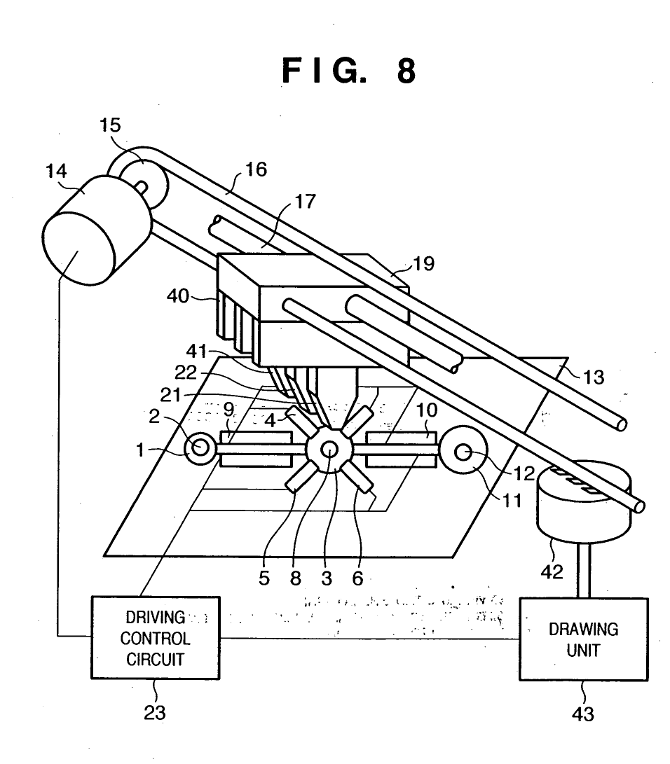

FIG. 8 is a view showing the arrangement of the third embodiment.

Reference numeral 42 denotes a head protection mechanism (cap) (recovery mechanism) 42 which covers injection heads 21, 22, and 41 in an unused state. Caps for the respective heads are independently prepared and connected to a drawing unit 43 through a tube.

A driving control circuit 23 recovers the injection heads 21, 22, and 41 in accordance with a predetermined program. More specifically, an operation of causing a drawing unit 43 to draw a waste fluid while causing the injection heads 21, 22, and 41 to appropriately discharge modifiers. With this arrangement, the injection heads 21, 22, and 41 are always kept fresh, and any error such as a discharge error can be prevented. When a sterilizing function is added to the cap 42, admixture of foreign substances can be prevented.

In this embodiment, a cartridge 40 and the injection head 41 are added, as shown in FIG. 8, unlike the first embodiment. These mechanisms stably fix modifiers added to a target modification minute object 8. The cartridge 40 is filled with a fixing solution. After modifiers are added by the heads 21 and 22, the fixing solution is spread by the head 41. With this operation, the modifiers stably stick to the target modification minute object 8. As in FIG. 1, electrical stimulation or heating by electrodes 4 to 7 of an aligner device may also be used. The remaining points are the same as in the first embodiment.

(Fourth Embodiment)

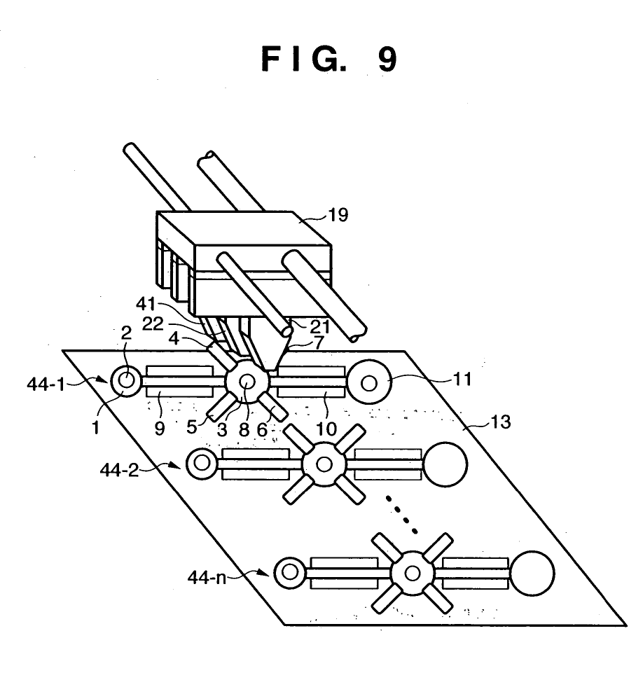

FIG. 9 is a view showing the arrangement of the fourth embodiment of the present invention.

The driving mechanism of a carriage 19 and a driving control circuit 23 are not directly relevant to the description and are not illustrated in FIG. 9. Although a protection recovery mechanism for injection heads can be added, as in the third embodiment, it is also omitted.

Referring to FIG. 9, reference numerals 44-1 to 44-n denote n (n can take an arbitrary value) minute object manipulation mechanisms each including input and output openings, feed mechanisms, and an aligner device, as in the first embodiment. The minute object manipulation mechanisms are formed on a glass base 13. The minute object manipulation mechanisms are arrayed such that the aligner devices are located under the moving locus of the carriage 19 having injection heads for modifiers and fixing solution.

The operation of the apparatus of this embodiment will be described next.

First, a target modification minute object 2 is introduced from an input opening 1 of the first minute object manipulation mechanism and fed to aligner devices 3 to 7 by a feed mechanism 9. The posture of a target modification minute object 8 is controlled and immobilized by the aligner device such that the surface to which first modifiers should be added opposes the injection head.

The injection head for the first modifiers is aligned by the carriage 19 and inject modifiers to modify the target modification minute object 8 whose posture is fixed by the aligner device of the first minute object manipulation mechanism. The above-described fixing operation is executed as needed. The posture of the minute object 8 is controlled and immobilized by the aligner device of the first minute object manipulation mechanism again to add second modifiers. Modification and fixing are executed in the same way as described above.

When the above operation is ended, the carriage 19 is moved to the position of the aligner device of the next second minute object manipulation mechanism. The work is executed in accordance with the same procedures as described above. The same operation as described above is also executed for target modification minute objects 2 introduced in the third, . . . , nth mechanisms. By repeating this operation, a large amount of minute objects can be processed at once.

In addition to the above-described method, the operation order may be changed.

For example, assume that a long time is required for fixing modifiers. In this case, after modifiers of one kind are added, and the fixing operation is started, the injection head is moved to the position of the next aligner device to start modification and fixing for another target modification minute object.

After modification and fixing for n target modification minute objects are ended, the minute objects are aligned. The injection head is returned to the aligner device of the first mechanism to start the second modification operation. With this method, since the standby time for fixing can effectively be used, minute objects can be processed at a higher speed than in the former case.

In the above description, a plurality of mechanisms each having the same arrangement as in the first embodiment are arrayed such that a plurality of target modification minute objects can simultaneously be modified. The same arrangement as in the second embodiment may be employed. In this case, the structure on the glass base 13 is complex. However, no large-scale mechanism such as the carriage 19 is necessary. In addition, all operations can be executed without exposing target minute objects to outer air.

As described above, according to the present invention, modifiers can selectively be added to a target object such as a target modification minute object. For this reason, the operation of causing a minute object to express a target function can efficiently be executed. Especially, when a plurality of kinds of modifiers should be added to a target object such as one target modification minute object, the effect is conspicuous.

The present invention is not limited to the above embodiments and various changes and modifications can be made within the spirit and scope of the present invention. Therefore, to apprise the public of the scope of the present invention, the following claims are made.

What is claimed is:

1. A target object modification apparatus comprising:
an aligner device configured to be able to manipulate a posture of a supplied target modification minute object;
first feed means configured to be able to supply the target modification minute object to said aligner device; and
injection means configured to be able to inject modifiers onto the target modification minute object after the target modification minute object is set to a predetermined posture by said aligner device.

2. The apparatus according to claim 1, further comprising an opening from which the modified target modification minute object is extracted, and second feed means for feeding, to the opening, the target modification minute object after fixing the modifiers.

3. The apparatus according to claim 2, further comprising a storage reservoir to store the target modification minute object after fixing the modifiers,
wherein said second feed means feeds the target modification minute object after fixing the modifiers to the storage reservoir.

4. The apparatus according to claim 1, further comprising a target modification minute object reservoir which can store a predetermined amount of target modification minute objects, and a modifier reservoir which can store a predetermined amount of modifiers,
wherein said first feed means feeds each target modification minute object from said target modification minute object reservoir to said aligner device, and said injection means is connected to said modifier reservoir.

5. The apparatus according to claim 4, wherein each of said target modification minute object reservoir, said modifier reservoir, and said storage reservoir to store the target modification minute object after fixing the modifiers has a cartridge shape and is detachable.

6. The apparatus according to claim 1, further comprising a fixing device to stably fix the modified target modification minute object.

7. The apparatus according to claim 1, further comprising a recovery mechanism to execute at least one of cleaning and sterilization of said injection means.

8. The apparatus according to claim 1, wherein said aligner device has a structure in which a plurality of manipulation electrodes are arranged around a recessed hole.

9. The apparatus according to claim 1, wherein a plurality of aligner devices are arrayed to be able to simultaneously modify a plurality of target modification minute objects.

10. A control method for a target object modification apparatus, comprising:
a supply step of supplying a target modification minute object to an aligner device capable of manipulating a posture of the target modification minute object; and
a driving control step of, after the target modification minute object is set to a predetermined posture by the aligner device, executing driving control to cause an injection head to inject modifiers onto the target modification minute object.
